(19) United States
(12) Patent Application Publication
(10) Pub. No.: US 2003/0005798 A1
(43) Pub. Date: Jan. 9, 2003

(54) Stud installation tool

(76) Inventor: Stanley Jason Kuchar, New Lothrop, MI (US)

Correspondence Address: SWARTZ & WILSON, P.L.C., ATTORNEYS AT LAW, SUITE 200, 908 COURT STREET, SAGINAW, MI, 48602, US

(21) Appl. No.: 09/900,736

(22) Filed: Jul. 9, 2001

(51) Int. Cl. B25B 7/02

(52) U.S. Cl. 81/426

(57) ABSTRACT

A tool for installing a traction stud including a threaded shank having a pointed ground engaging end and an opposite end mounting a transverse head on a snowmobile drive belt so that the head bears against the inside surface of the track and the pointed end projects outwardly beyond the outside surface of the track. The tool includes a pair of clamping members which have pivotally coupled together along one lateral side of the belt and have free terminal ends mounting opposing clamping jaws which swingably move between spread positions spaced from the belt and closed positions clamped to the belt. Handles are provided on the ends of the elongate member laterally adjacent the track for moving the clamps between open and closed positions. One of the clamps mounts the head of the stud and the other of the jaws includes an enlarged aperture for receiving the pointed end after the stud is inserted through the belt when the jaws are closed and a turning tool which internally mounts a nut that is threaded onto the shank after the stud is forced through the belt.

### BACKGROUND OF THE INVENTION

1. Field of the Invention

This invention relates to a tool for inserting a traction stud into a snowmobile belt and more particularly to a tool which will push the stud through the belt and hold the stud in position while a wrench couples a fastener nut to the stud.

2. Description of Prior Art and Objects

Studs for snowmobile tracks have been provided heretofore such as that illustrated in U.S. Pat. No. 5,234,266 issued to James R. Musselman, et al on Aug. 10, 1993. Such snowmobile studs are sometimes referred to as push-through studs each having a shank which passes through a bore through the track and integrally mounts, at one end, an integral head which bears against the inner surface of the track. A nut is threaded onto the threaded shank and the other end includes a terrain engageable end for increasing the traction capabilities of the track, particularly when traveling on icy surfaces. The track bore through which the shank of the stud passes is relatively small and considerable force is required to force the stud through the track.

The studs are installed in a plurality of different patterns, however, as many as 240 such studs have been installed in a single track. The installation of such studs has heretofore been time consuming and very difficult. Such installation is particularly difficult for the elderly who have limited strength and dexterity. Accordingly, it is an object of the present invention to provide a tool for quickly inserting traction studs into an endless snowmobile drive belt.

It is a further object of the present invention to provide a hand tool for more easily inserting traction studs into an endless snowmobile belt.

A still further object is to provide a hand tool of the type descirbed which requires little dexterity to operate.

It is yet another object of the present invention to provide a plier type tool which can be utilized to hold the stud prior to and while it is being inserted through the snowmobile drive belt.

Snowmobile drive belts are relatively wide and thus it has been found, according to the present invention, that the tool be of such construction that the clamping jaws include elongate arms which will have opposite pivotally coupled ends and jaw mounting clamp ends that are spaced apart a distance equal to one half of the width of the track so that the pivotally coupled ends adjacent one lateral side of the track are spaced from the clamping jaws by a distance equal to at least one half of the width of the track. Accordingly, it is another object of the present invention to provide a new and improved plier tool for inserting a traction stud with a pair of elongate members pivotally coupled together adjacent one lateral side of the track and having clamping members spaced from the pivotal ends a distance equal to at least one half of the width of the track.

A further object of the present invention is to provide a plier tool for inserting a traction stud of the type described into a snowmobile drive belt including one clamping jaw which mounts the head of the snowmobile stud on the inner side of the belt and an opposite clamping jaw having an aperture therethrough for receiving the terrain engaging end of the stud on the outer side of the belt after the tool has pushed the terrain engaging end through the snowmobile belt for the inner belt side to the outer belt side.

A still further object of the present invention is to provide a plier type tool of the type described wherein one of the clamping jaws includes a bore of sufficient size to receive a fastener nut to be threadedly mounted on the traction stud.

A still further object of the present invention is to provide a plier tool of the type described wherein the bore through the one clamping jaw is of sufficient size to receive a rotatable tool, such as a socket wrench, for turning a threaded nut onto the threaded shank of the snowmobile stud after the shank has been forced through the track by the clamp members.

One of the problems associated with the mounting of the traction stud on a snowmobile track is insuring that the head is held while the nut is threaded thereon. Heretofore, the head of the snowmobile stud, such as that illustrated in the aforementioned patent, includes a hexagonal shaped, centrally disposed recess therein for receiving an allen wrench which holds the stud against rotation as the nut is being threaded thereon. Accordingly, another object of the present invention is to provide a plier type tool of the type described including new and novel mechanism for precluding rotation of the head as a nut is being threaded on the stud.

Still another object of the present invention is to provide a plier tool of the type described wherein the clamping jaw which mounts the head of the snowmobile stud includes a projection thereon for preventing rotation of the stud about its axis as the nut is being threaded thereon.

A further object of the present invention is to provide a non-circular projection on the clamping jaw mounting the head of the snowmobile stud to be received in a complementally formed projection on the head of the snowmobile stud to preclude rotation of the stud as the nut is being threaded thereon.

It is important to note that, after the clamping jaws are operated to push the stud through the track, provisions be made for locking the clamping jaws to the track to hold the jaws in position so that the user may thereafter free his hands from the clamping tool to operate a ratchet wrench for turning a nut onto the stud with a socket wrench. Accordingly, it is another object of the present invention to provide new and novel mechanism for locking a plier type tool, of the type described, to a snowmobile traction belt after it has inserted a stud into the belt.

Another object of the present invention is to provide new and novel plier type tool of the type described which includes locking plier mechanism.

A further object of the present invention is to provide a plier type tool of the type described including provisions for allowing a ratchet operated socket to turn a nut onto the stud while the stud is clamped to the track.

Still another object of the present invention is to provide a tool of the type described including so-called vice grip handles for detachably locking the clamping jaws to the snowmobile track after a stud has been inserted into the track and while a nut is being threaded onto the threaded stud shank.

It is yet another object of the present invention to provide a tool for detachably coupling a threaded nut to a threaded shank via a pair of clamping jaws clamped to opposite sides of the resilient snowmobile belt.

Still another object of the present invention is to provide a tool for mounting a threaded shank on a resilient snowmobile belt including a pair of opposed clamping jaws clamped to opposite sides of a rubber track including one clamping jaw for preventing rotation of the shank and another for receiving a nut to be threaded onto the shank.

These and other objects and advantages of the present invention will become more readily apparent of those of ordinary skill and the art as the description thereof proceeds:

### SUMMARY OF THE INVENTION

A stud installation tool for installing a traction stud onto a resilient endless belt, the stud having a threaded shank with a terrain engaging end and an opposite end mounting an enlarged head which is adapted, when installed, to bear against an inner face of the endless belt, the threaded shank when installed being adapted to threadedly receive a threaded nut on the outer face of the endless belt, the stud installation tool comprising: a pair of swingably coupled clamping heads moveable between spaced apart open positions and closed positions detachably clamped to the opposite sides of the belt; one of the clamping heads detachably mounting the enlarged head of the traction stud; the other of the clamping heads having an aperture therethrough for freely receiving the terrain engaging end when the clamping heads are in the closed position; and handles for swingably moving the heads between the open and closed positions to push the terrain engaging end through the belt from the inside face to the outer face and clamp the stud while a tool fastens a fastener to the threaded shank.

### DESCRIPTION OF THE DRAWINGS

The invention may more readily be understood by reference to the accompanying drawings, in which:

FIG. 1 is a side elevational view of a snowmobile including an endless drive belt on which a traction stud is mounted with apparatus constructed according to the present invention;

FIG. 2 is a greatly enlarged sectional end view, taken along the section line 2-2 of FIG. 1 illustrating the top run only of the endless snowmobile drive belt having a plier tool mounted thereon according to the present invention;

FIG. 3 is a side elevational view of a plier tool constructed according to the present invention in an open position for inserting a traction stud through the snowmobile belt illustrated in chain lines;

FIG. 4 is a slightly enlarged side elevational view, similar to FIG. 3, illustrating the plier tool constructed according to the present invention, partly in section, clamped to opposite sides of a snowmobile belt after having inserted the stud into the belt and a socket wrench having turned a fastener nut onto the stud;

FIG. 5 is an enlarged sectional end view, taken along the section line 5-5 of FIG. 4, more particularly illustrating the Allen wrench construction on the lower clamping jaw for precluding rotation of the stud as the nut is being threaded thereon.

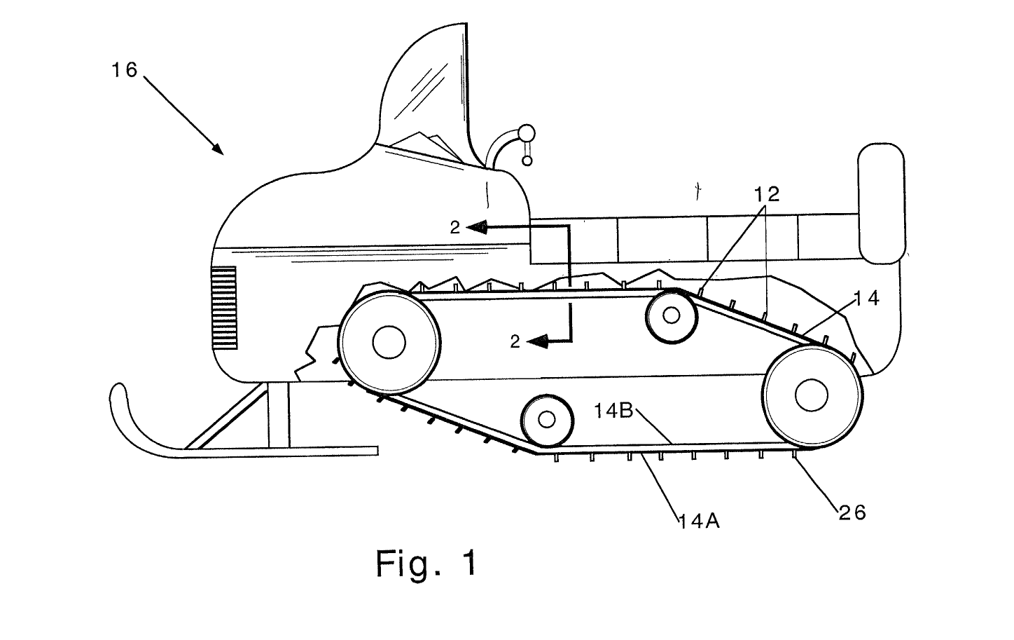

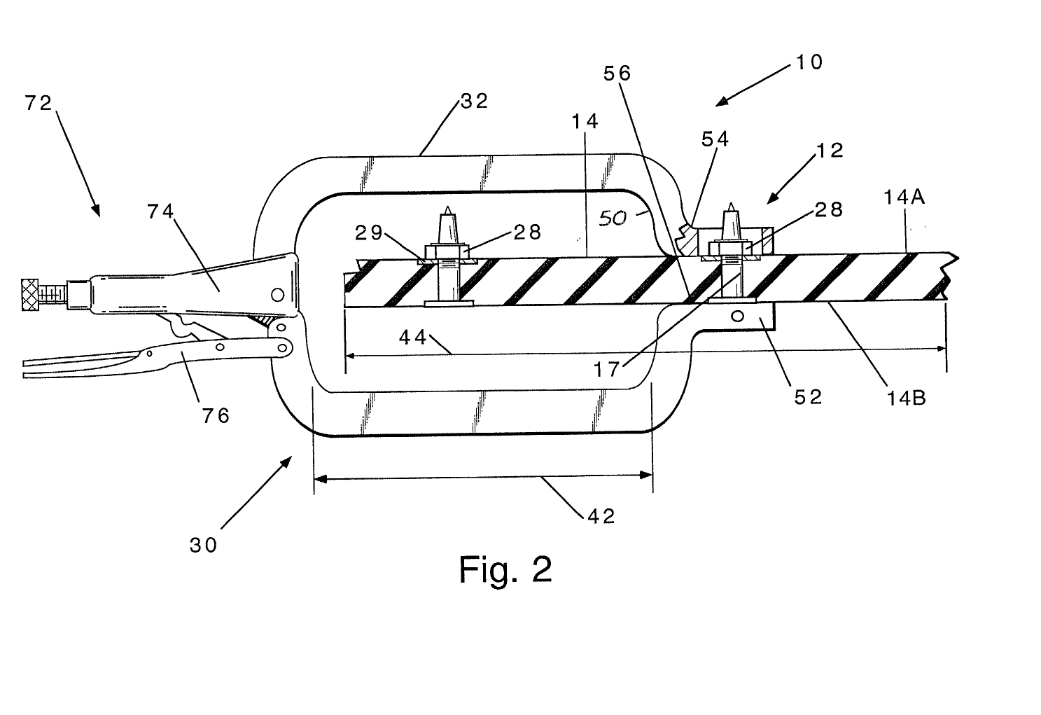

### DESCRIPTION OF PREFERRED EMBODIMENT

A stud installation tool, generally designated 10, constructed according to the present invention, is particularly adapted for installing a one-piece traction stud, generally designated 12, on an endless, resilient snowmobile drive belt 14 mounted on a snowmobile, generally designated 16 such as that described in U.S. Pat. No. 5,716,112, issued to Michael Staszak, on Feb. 10, 1998, and incorporated herein by reference as though recited word-for-word herein. The drive belt may include a plurality of stud receiving openings 17 therethrough.

The snowmobile stud 12, is more particularly illustrated in U.S. Pat. No. 5,234,266, issued to James R. Musselman, et al, on Aug. 10, 1993, which is incorporated herein by reference as though filly set forth herein word-for-word, and includes a cylindrical threaded shank 18 (FIG. 5) having an elongate axis 20, an enlarged head 22, at an axially inner end thereof and an axially outer, terrain engageable conical end 24 terminating in a ground engaging point 26 which can penetrate an icy surface to improve the traction characteristics of the drive belt 14. A hexagonally shaped recess 27 is provided in the central portion of the axially inner surface of head 22 for receiving an installation tool as will be more particularly described hereinafter.

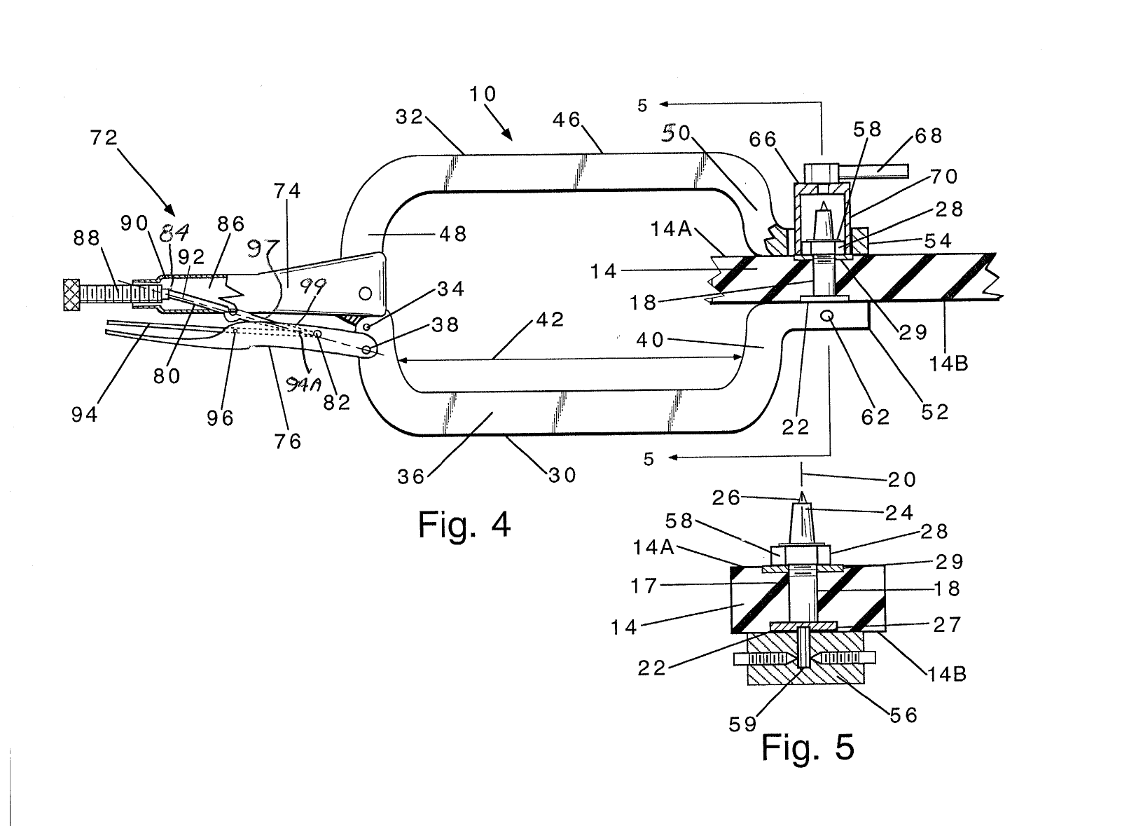

A threaded fastener, such as a nut 28, is threaded onto the outer end of the threaded shank 18. A suitable washer or backer plate 29 can be placed between the nut 18 and the outer track surface 14A of the track 14. The backer plate 29 has an area substantially greater than the track engaging area of nut 28 to disburse the clamping forces over a larger area. When installed on the track 14 by the tool 10, the head 22 is imbedded in and bears against the inner track surface 14B as illustrated in FIG. 4.

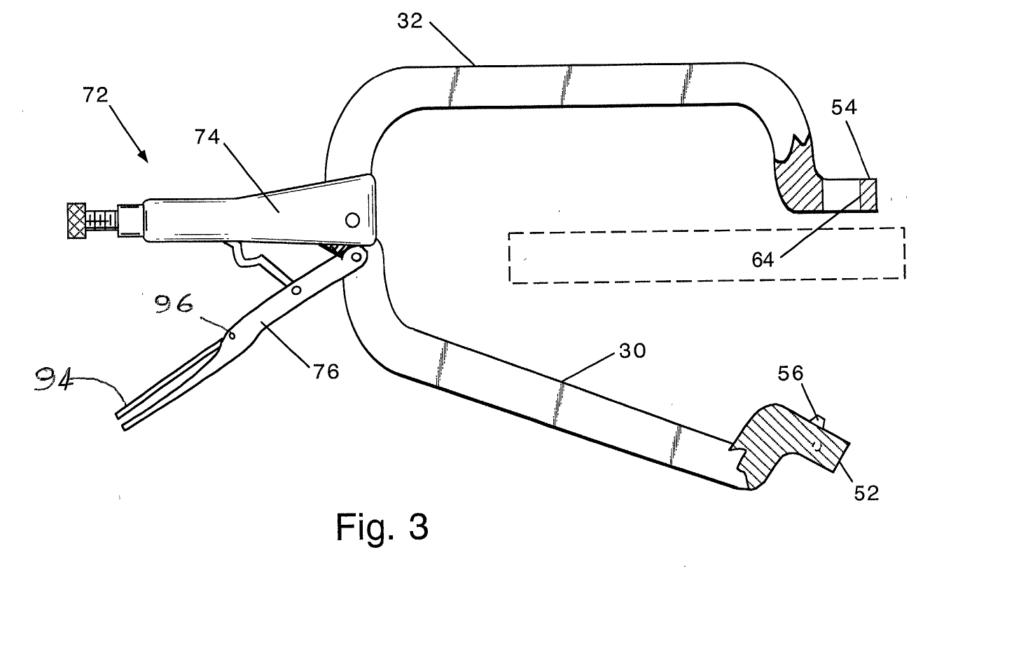

The stud installation tool 10 includes a pair of inner and outer swingably coupled, elongate clamping members generally designated 30 and 32, pivotally coupled together via a pivot pin 34 for swinging movement between the spread, open positions removed from the belt, illustrated in FIG. 3, and the closed clamping positions illustrated in FIG. 4. The clamping member 30 is C-shaped or U-shaped and includes a base 36 mounting an outer leg 38 and a spaced inner leg 40. The legs 38 and 40 are spaced apart a predetermined distance 42 which is at least one-half the width 44 of the snowmobile traction belt 14. The opposing outer clamp C-shaped clamp member 32 is similarly formed and includes a base 46 mounting an outer leg 48 and an inner leg 50. The inner confronting legs 38 and 48 are pivotally coupled together via the pivot pin 34.

The lower inner clamp leg 40 mounts a lower clamping jaw, generally designated 52, opposing an upper clamping jaw 54 mounted on the opposing upper leg 50. The lower clamping jaw 52 includes an anvil or flat plate 56 which supports the stud head 22 thereon to move the stud shank 18 and conical ground engaging end 26 into and through one of the stud openings 17 in belt 14. The diameter of the hole 17 is slightly less than the outer diameter of the stud shank 18 so that considerable force is required to push the stud shank through the belt 14.

To prevent the stud 12 from rotating about its longitudinal axis 20, a hexagonal stub shaft 56 (FIG. 5) projects upwardly from the upper face 58 and is received in a complementally formed hexagonal receptacle 27 provided in the stud head 22. The stud shaft 58 is disposed in a recess 59 in jaw 52 and is detachably held therein via a pair of opposing set screws 62 which detachably engage opposite sides of the hexagonal stub shaft 58.

The upper clamping jaw 54 includes an enlarged bore 64 therethrough for receiving the terminal end 24 of the cylindrical threaded shank 18 after the terminal end 24 has passed through the belt 14, the enlarged bore 64 also receives the nut 58 to be threaded onto the shank 18 and a deep well socket 66 which is coupled to a ratchet wrench 68 of conventional construction. The deep well socket 66 includes an annular side wall 70 which is received within the bore 64 provided in the upper jaw 54.

A handle assembly, generally designated 72, is provided for opening and closing the lower and upper clamps 30 and 32 and includes a substantially U-shaped handle 74 fixed to the upper clamp 32 and an opposing, substantially U-shaped moveable handle 76 swingably mounted on the lower clamp 30 via a pivot pin 38. The handle assembly 72 is sometimes referred to as a locking plier assembly and a “vice grip” which is discussed and illustrated in U.S. Pat. No. 5,582,084, U.S. Pat. No. 2,280,005; U.S. Pat. No. 2,514,130; U.S. Pat. No. 3,192,804; U.S. Pat. No. 4,541,312; U.S. Pat. No. 4,546,680; U.S. Pat. No. 4,709,601; U.S. Pat. No. 5,056,385; and U.S. Pat. No. 5,435,214, which are incorporated herein by reference as though fully set forth herein. Disposed between the two handles 74 and 76 is a toggle link 80 which is rotatably coupled to the moveable handle 76 via a pivot pin 82. The other free end 84 of toggle link 80 bears against a pivot 86 inside in the handle 72 at the end of an adjustment screw 88 threadedly adjustable in a nut 90 fixed to the end of the handle 72.

The relative movement of the parts of the locking handle assembly between the open and closed positions is shown in FIGS. 3 and 4. The toggle link 80 locks when the pivot 82 moves to an over center position above the pivot line 92 intersecting the pivots 86 and 38 as illustrated in FIG. 4. In this over center position of the toggle link, the handles 76 and 72 are locked together and the users hands are then free to handle the nut 28 and to operate the socket wrench 68 to turn the socket 66 and the nut 28 onto the threaded shank 18 of the stud 12.

A quick release lever 94 is pivotally coupled to the moveable handle 76 via a pivot 96 and includes a free end 97 positioned within the substantially U-shaped handle 76. The quick release lever 94 has a camming projection 94A extending forwardly of the pivot pin 96 for engaging a camming portion 99 on the lever 80 to displace the lever 76 downwardly from the position illustrated in FIG. 4 so that the pin 82 removes itself from an over center position thereby allowing the clamping jaw 30 to collapse downwardly.

### The Operation

The snowmobile drive belt 14 may be removed from the snowmobile and a plurality of holes 17, having a diameter slightly less than the diameter of the threaded shanks 18, are bored through the belt between the inner and outer belt faces 14B and 14A, respectively, at any one of a plurality of different locations depending on various studding patterns that may be utilized.

The tool 10 will initially be assumed to be in the open position illustrated in FIG. 3 with the clamps 30 and 32 separated. Prior to mounting the clamping jaw 54 on the outer belt face 14A, an enlarged washer 29 may be inserted onto the outer face 14A of the belt 14 and the washer opening aligned with the selected opening 17. The stud head 22 is positioned on the lower clamping jaw 52 with the hexagonal stud recess 27 received by the hexagonal projection 50. The tool 10 is moved to a position such that the upper clamp bore 64 in the upper clamping jaw 54 bears against the outer track surface 14A and is aligned with one of the passages or bores 17 through the belt 14. The lower jaw 52 and stud 12 thereon are positioned so that conical point 26 is aligned with the opposite side of the selected track opening 17. The moveable handle 76 is squeezed or pushed toward the upper handle 72 to upwardly move the lower clamp jaw 52 and stud 12 thereon toward the upper jaw 54 to push the stud point 26 and outer end portion threaded shank 18 through the selected opening 17 from the spread position illustrated in FIG. 3 until the stud 12 is fully inserted into the opening 17 as illustrated in FIG. 4.

The locking lever 94 is then moved to the over center position, in which the pivot 82 is above the pivot line 92 intersecting pivots 86 and 38, so that the handles 74 and 76 are locked in the positions illustrated in FIG. 4 and may be manually released to continue to hold the stud 12 fully inserted through the belt 14 without the necessity of the operator holding the handles 76 and 74. The fastener nut 28 is then disposed into the deep well socket 66 which, while carrying the nut 28 is inserted into the bore 64. The ratchet wrench 68, which is coupled to the deep well socket 66 is ratcheted to turn the nut 28 onto the threaded shank 18 until the stud is adequately held to the belt 14 and the stud head 22 is recessed into the inner track surface 14B.

After the first stud 12 is adequately coupled to the belt 14, the release lever 94 is actuated to release the handle which will allow the moveable jaw 52 to return to the spread position illustrated in FIG. 3. The operation may be repeated to insert another stud into another opening in the belt.

It is to be understood that the drawings and descriptive matter are in all cases to be interpreted as merely illustrative of the principles of the invention, rather than as limiting the same in any way, since it is contemplated that various changes may be made in various elements to achieve like results without departing from the spirit of the invention or the scope of the appended claims.

What I claim is:

1. A plier tool for inserting a traction stud including
a threaded shank having
an elongate axis,
an enlarged
terrain engaging end, and
transverse stud head at the opposite end of the shank through a resilient endless drive belt having inner and outer opposite sides, said plier tool comprising:
first and second swingably coupled opposed elongate members having
first and second opposed clamping jaws, respectively, moveable between spaced apart positions removed from the belt and closed positions, bearing against the inner and outer sides, respectively, of the belt; and
said first jaw including means for mounting the enlarged transverse stud head on the inner side of the belt;
said second jaw adapted to be mounted on the outer side of said belt;
handle means for relatively swinging said first and second elongate members in opposite to-and-fro directions to move said first and second jaws, respectively, between said spaced apart positions and said closed positions clamped to the inner and outer opposite sides, respectively, of the belt and move the terrain engaging opposite end of the traction stud through the belt from the inner side through the outer side to a position projecting outwardly beyond the outer side of the belt;
said second jaw having an aperture therethrough for detachably freely receiving said terrain engaging end in the closed position clamped to the outer side of the belt.

2. The plier tool set forth in claim 1 wherein said aperture in said second jaw comprises a nut receiving aperture having an internal face radially spaced from the shank of the stud a sufficient distance to receive a threaded nut to be threadedly coupled to said shank.

3. The plier tool set forth in claim 2 wherein said aperture comprises a wrench receiving aperture of sufficient size to detachably receive a wrench for receiving and turning the nut about said axis onto said threaded shank.

4. The plier tool set forth in claim 3 wherein said first jaw includes means engageable with the head for precluding rotation of the shank about its axis relative to said first jaw as the wrench turns a nut onto said threaded shank.

5. The plier tool set forth in claim 1 wherein said first jaw includes means engageable with the head for precluding rotation of the shank about its axis.

6. The plier hand tool set forth in claim 5 wherein said first jaw comprises a head mounting plate and said means for precluding rotation of the shank includes a non-circular projection on the plate receivable in a complementally formed non-circular recess on the head of the stud.

7. The plier tool set forth in claim 5 wherein said means for precluding rotation of said shank includes a hexagonal stub shaft projecting away from said first jaw toward said second jaw.

8. The plier tool set forth in claim 1 wherein said second elongate member includes a first end for mounting said second jaw against the outer side of the resilient endless belt and a second end; said first elongate member including
a first end for mounting said first one jaw on the inner side of the belt; and
a second end pivotally mounted on said second end of said second elongate member;
said handle means including a fixed handle coupled to said second end of said second elongate member and a moveable handle swingably coupled to said second end of said first elongate member for moving said first elongate member and said jaw, mounting the stud thereon, for swinging movement between said spaced apart position, removed from the inner side of the belt, and said closed position to move the terrain engaging opposite end of the stud through the belt to a position in which the head bears against the inside of the belt and the terrain engaging end projects outwardly beyond the outer side of the belt.

9. The plier tool set forth in claim 8 wherein said aperture in said second jaw includes a bore therethrough of sufficient size to receive a threaded fastener adapted to be threaded onto the threaded shank.

10. The plier tool set forth in claim 9 wherein the aperture in said second jaw includes a bore therethrough of sufficient size to rotatably receive a rotatable fastener turning tool which internally receives the threaded fastener.

11. The plier tool set forth in claim 10 including means for detachably locking said moveable handle to said fixed handle when said first and second jaws are clamped to the inner and outer sides, respectively, of the belt.

12. A plier tool comprising:
means for inserting a traction stud, having an elongate threaded shank with an enlarged head at one end and a pointed terrain engaging opposite end, through an endless resilient drive belt and detachably coupling the stud to the belt including
a pair of elongate members having a pair of opposing jaws at one end and handle means at the opposite end for moving said jaws toward and away from each other between spaced apart position removed from the belt and closed clamping positions detachably clamped to opposite sides of the belt;
one of said jaws including means for detachably mounting the enlarged head thereon and the other of said jaws including an enlarged aperture for detachably receiving the terrain engaging opposite end, a nut to be threadedly coupled to the shank and a turning tool for turning the nut onto the threaded shank, when the jaws are in said clamping positions.

13. The plier tool set forth in claim 12 wherein said means for mounting the enlarged head includes an anvil; and means on said anvil for preventing rotation of said shank relative to the anvil as the nut is threaded onto the shank.

14. The plier tool set forth in claim 13 wherein said handle means includes
a fixed handle fixed to said other jaw;
a moveable handle pivotally coupled to said one jaw and
means for detachably locking said moveable handle to said fixed handle when said jaws are in said closed positions to detachably hold the stud to the belt when the nut is turned thereon.

15. The plier tool set forth in claim 14 wherein said one jaw includes a non-circular projection thereon for being received in a complementally shaped non-circular recess in the head of the stud.

16. A traction stud installation tool for installing a threaded traction stud with an enlarged head on an inner side of an endless resilient drive belt, having
lateral edges and
inner and outer spaced apart belt sides extending between the edges, and
a coupling nut threadedly received by the traction stud on the outer side of the belt, said tool comprising:
a pair of elongate mounting arms having
intermediate portions swingably coupled together laterally outwardly of the belt,
laterally inner free terminal end portions, provided with confronting clamping jaws, disposed in confronting relation with the belt faces, and
laterally outer terminal handle ends coupled to said intermediate portions for moving said inner free terminal end portions toward and away from each other between spaced apart open positions and less spaced apart, closed positions clamped to the opposing faces;
one of said jaws including an anvil for mounting the enlarged head of the traction stud on the inner side of the belt and
the other of said jaws including an aperture therethrough for receiving the shank and the nut threaded on the shank on the outer side of the belt when the inner terminal end portions are in said less spaced apart closed positions.

17. A tool for detachably coupling a threaded nut disposed on the outer side of an endless traction belt to a threaded shank of a traction stud extending through the belt and having an integral enlarged head disposed on an inner side of the traction belt stud tool comprising:
a pair of opposing relatively moveable jaws;
one of said jaws detachably mounting the enlarged head on the inner side of the belt
means swingably coupling the jaws for movement toward and away from each other for movement between spaced apart positions removed from the belt and closed clamping positions exerting clamping forces on opposite sides of the belt to force said threaded shank through the belt from the inner side of the belt through the outer side of the belt;
the other of said jaws including aperture means therethrough for freely receiving the shank extending through the outer side of the belt and the nut to be threadedly received on the shank.

18. The tool set forth in claim 17 wherein said one jaw includes means for precluding rotation of said shank as the nut is being threaded thereon.

19. The tool set forth in claim 17 including a rotary, hollow nut turning wrench received in said aperture and receiving said nut therein for turning said nut onto said shank.

20. A stud installation tool for installing a traction stud on an endless traction belt having inner and outer sides, the stud having a threaded shank with a terrain engaging outer end and an opposite end integrally mounting an enlarged head, the head being adapted to be disposed against the inner side of the belt and the terrain engaging opposite end being adapted to project outwardly beyond the outer side when the stud is installed on the belt; said tool comprising:
a pair of swingably coupled clamping heads relatively moveable between spaced apart open positions removed from the belt and less spaced apart closed positions detachably clamped to the opposite sides of the belt;
one of said clamping heads including means for supporting the enlarged head of the traction stud for movement therewith between said open and closed positions to force said terrain engaging end through the belt from the inner side when said heads are in said open positions through the outer side of the belt when said heads are in said closed positions; and
the other of the clamping heads having an aperture therethrough for freely receiving the terrain engaging end when said heads are in said closed positions, and
handle means coupled to said clamping heads for relatively swinging said heads between said open and closed positions.

21. The tool set forth in claim 20 wherein said aperture includes a bore for receiving a nut to be threaded on the threaded shank of the stud.

22. The tool set forth in claim 21 wherein said bore is of sufficient size for receiving a rotatable tool for rotating the nut and threading it onto the shank of the stud.

23. The tool set forth in claim 22 wherein said one clamping head includes means for precluding rotation of the threaded shank as the nut is threaded thereon.

24. The tool set forth in claim 23 wherein said means for precluding rotation comprises a stub shaft having a terminal end projecting beyond said one clamping head, and means detachably mounting said stub shaft on said one clamping head.

25. A tool for inserting a traction stud through a resilient traction belt, the stud including a threaded shank, for detachably threaded receiving a transverse fastener, having an enlarged transverse head at one end and an opposite terrain engageable free end, said tool comprising:
first and second pivotally coupled opposing elongate clamp members, having first and second opposing pivot ends, respectively, pivotally coupled together and first and second opposing terminal clamping jaws, respectively, moveable between spaced apart open positions and closed clamping positions clamped to opposite sides of a resilient traction belt;
handle means coupled to said pivot ends for detachably moving said clamp members between said open positions and closed clamping positions;
locking means coupled to said handle means for detachably locking said clamp members in said closed positions;
one of said clamping jaws including means for mounting the head of the stud and the other of said clamping jaws having a passage therethrough for receiving and passing the ground engaging end of the stud when said jaws are in the closed clamping positions.

26. The tool set forth in claim 25 including rotation inhibiting means on said one clamping jaw for precluding rotation of the shank about the axis.

27. The tool set forth in claim 26 wherein said rotation inhibiting means comprises a non-circular stub shaft projecting from said one clamping jaw toward said other clamping jaw.

28. The tool set forth in claim 26 wherein said rotation inhibiting means includes a non-circular projection on said one clamping jaw adapted to be received in a complementally formed non-circular recess on said head.

29. The tool set forth in claim 28 wherein said non-circular projection comprises a bar having a hexagonal cross-section.

30. The tool set forth in claim 25 wherein said passage in said other of said clamping jaws is configured to receive a threaded fastener to be threaded onto said threaded shank.

31. The tool set forth in claim 25 wherein said threaded shank has a predetermined diameter, said passage in said other of said clamping jaws is a circular passage of substantially greater diameter greater than the predetermined diameter of the threaded shank.

32. The tool set forth in claim 31 wherein said passage comprises a wrench receiving bore for detachably receiving a socket wrench adapted to internally receive a nut for threading onto said shank.

33. A tool for installing a traction stud in an aperture extending through an endless, resilient snowmobile belt having inner and outer surfaces provided with at least one stud receiving aperture therethrough,
the snowmobile traction stud including
a cylindrical shank receivable in the aperture and having
an axis;
an inner end integrally mounting a transverse head for bearing against the inner surface, and
an outer opposite terrain engaging end for extending outwardly of the outer side of the track engaging the terrain to be traversed;
an intermediate threaded position between said ends;
said tool for mounting said shank in the stud receiving aperture comprising
a pair of elongate opposing U-shaped clamps each having a base mounting a pair of longitudinally spaced apart legs in opposing relation with the base and legs respectively on the other clamp;
means pivotally coupling one of said legs of each clamp to one of the opposing legs of the other clamp for relative swinging movement;
the other of said legs on said one of said clamps including an anvil jaw means for supporting said head of said stud thereon;
the other of said legs on the other of said clamps including a clamping jaw, opposing said anvil jaw, including an aperture therethrough for receiving said terrain engaging end and said threaded shank.

34. The tool set forth in claim 32 wherein said aperture in said clamping jaw opposing said anvil jaw is of such size as to receive an internal threaded fastener for threading on said threaded shank received in said aperture.

35. The tool set forth in claim 34 including a nut receiving wrench disposed in said aperture receiving the threaded fastener for turning the fastener onto the threaded shank.

36. The tool set forth in claim 35 wherein said clamping anvil includes a non-circular wrench projection thereon for being received in a non-circular recess in the head to preclude rotation of said head when said wrench is threading the fastener onto the shank.

37. The tool set forth in claim 33 wherein said clamping anvil includes a non-circular projection thereon projecting toward said clamping jaw for being received in a complemental non-circular recess in the head to preclude rotation of the stud about its axis.

38. The tool set forth in claim 33 wherein the belt has lateral edges spaced apart a predetermined distance; said terminal ends of said legs on each clamp are spaced apart a distance at least one-half said predetermined distance.

39. A tool for detachably installing a traction stud and threaded stud fastener to an endless resilient snowmobile drive belt,
the endless, resilient snowmobile drive belt having inner and outer sides;
the traction stud including:
an elongate shank having an elongate axis;
a terrain engaging outer end;
an opposite head mounting inner end;
an intermediate threaded shank portion between the ends;
an enlarged transverse head integrally mounted on the head mounting outer end;
the threaded fastener being adapted to thread onto the threaded shank portion;
said traction stud installation tool comprising:
a pair of swingably coupled clamping jaws;
one of said jaws detachably mounting the head of said stud to support the stud on the inner side of said belt;
the other of the clamping jaws having a fastener receiving passage therethrough for detachably receiving the threaded fastener on the outer side of said belt; and
handle means coupled to said clamping jaws for moving said jaws between spaced apart open positions removed from said track and less spaced apart closed positions with said other clamping jaw clamped to the outer side of the track and said one jaw clamped to the inner side of the track to move the terrain engaging end from the inner side of said belt through said belt to said outer side of the belt to be received by the threaded fastener held by said other jaw.
